(19) United States
(12) Patent Application Publication
(10) Pub. No.: US 2022/0291651 A1
(43) Pub. Date: Sep. 15, 2022

(54) METHOD, DEVICE AND SYSTEM FOR OPTIMISING DATA TRANSMISSION BETWEEN CONTROL DEVICES AND CLOUD SYSTEMS

(71) Applicant: WAGO Verwaltungsgesellschaft mbH, Minden (DE)

(72) Inventors: Thomas GAUS, Fluorn-Winzeln (DE); Stefan EGGERT, Niedereschach (DE); Josha DITTGEN, Villingen-Schwenningen (DE)

(73) Assignee: WAGO Verwaltungsgesellschaft mbH, Minden (DE)

(21) Appl. No.: 17/831,164

(22) Filed: Jun. 2, 2022

Related U.S. Application Data
(63) Continuation of application No. PCT/EP2020/084131, filed on Dec. 1, 2020.

(30) Foreign Application Priority Data
Dec. 4, 2019 (DE) 10 2019 218 827.3

(51) Int. Cl. G05B 19/05

(52) U.S. Cl. CPC G05B 19/054; G05B 19/056; G05B 19/052; G05B 2219/163; G05B 2219/15038

(57) ABSTRACT

A method for optimizing data transmission in an automation system between a control device and at least one cloud system, as well as to a corresponding control device, a corresponding cloud system, and a control system. The method includes at least the following steps: determining a data transmission characteristic of at least one transmission path that is available for data transmission by means of a first and/or a second determination component; analyzing whether the data to be transmitted can be transmitted, based on the data transmission characteristic determined; selecting at least one action from a set of actions in order to adapt the data to be transmitted and/or the transmission path if the data to be transmitted cannot be transmitted, so as to allow the data transmission; and performing the at least one selected action.

This nonprovisional application is a continuation of International Application No. PCT/EP2020/084131, which was filed on Dec. 1, 2020, and which claims priority to German Patent Application No. 10 2019 218 827.3, which was filed in Germany on Dec. 4, 2019, and which are both herein incorporated by reference.

### BACKGROUND OF THE INVENTION

### Field of the Invention

The present invention relates to a method, devices, and a system for optimizing data transmission in an automation system between at least one control device and at least one cloud system.

### Description of the Background Art

Automation systems are systems that are used in the field of automation technology and serve to automate technical machines and/or installations. The more independently of human intervention the machine/installation in question can be operated, the higher the degree of automation.

In particular, the degree of automation can be increased by improved signal acquisition (which is to say improved sensors), by improved signal processing, and by improved signal or data transmission. In addition to relieving human workers of dangerous, strenuous, or routine activities, the increase in the degree of automation allows improvements in quality, higher performance of the machine/installation, and a reduction in labor costs, among other things.

Automation systems are controlled or regulated by control devices. In addition, sensors are employed for signal acquisition. The control device converts the acquired signals and generates control commands, which are routed to corresponding actuators and are executed by the same.

In particular, programmable logic controllers, so-called PLC controllers, which can communicate with corresponding sensors and/or actuators in order to carry out a wide variety of tasks in the context of automation technology, are employed as control devices in automation technology.

Recently, control devices are being linked to external and/or internal cloud systems. A variety of advantages can be achieved by this means, such as, e.g., increased flexibility, improved scalability, lower costs, greater efficiency, and the like. Internal cloud systems or private cloud systems can, in particular, be part of an internal IT infrastructure.

In particular, the linking of control devices to cloud systems allows data to be sent both from the control device to the cloud system (uplink) and from the cloud system to the control device (downlink). The cloud system can store, analyze, process, and/or make the received data available again to the control device and/or other users. For example, information can be shared and/or complex data evaluation steps can be offloaded in this way.

In order to be able to ensure a reliable automation system and/or a high degree of automation, it is crucial for the data to be transmitted timely, reliably, correctly, and completely. Often, a large amount of data must be sent from the control device/devices of an automation system to one or more cloud systems in a very short time window. It is likewise possible that the data must be sent from the cloud system/systems to one or more control devices. A sufficiently high data transmission rate is required for this purpose.

The data transmission rate defines the quantity of data that can be transmitted within a certain time. The data transmission rate varies as a function of the location, time of use, and the transmission paths or transmission methods used between the systems. Contractually agreed services with a provider can also have an effect on the possible data transmission rate. Furthermore, the theoretically possible data transmission rate generally differs greatly from the transmission rate available in the practical application. In the case of a data transmission rate that is too low, it can happen that required data are not sent or are not sent completely and correctly to the cloud system or to the control devices and/or that there is a large time difference during sending. Moreover, the sending of very large quantities of data (for example, a firmware update for the control device or log files) can lead to a “blocking” of the data connection or of the transmission path. The failure of the data to arrive or an incorrect transmission can have adverse effects on the control of the automation system. For example, safety-critical alarms may fail to occur, or important subsequent processes (e.g., automatic generation of service calls, communication back to the controller) may not be carried out.

### SUMMARY OF THE INVENTION

It is therefore an object of the present invention to optimize the data transmission in automation systems between a control device, in particular a PLC control device, and at least one cloud system in such a manner that data can be transmitted timely, reliably, correctly, and completely between the at least one control device and the at least one cloud system (in the uplink and/or downlink).

The object is attained, for example, by a method for optimizing data transmission in an automation system between a control device, in particular a PLC control device, and at least one cloud system. The method includes at least the following steps:

Determining a data transmission characteristic of at least one transmission path that is available for data transmission by means of a first and/or a second determination component, wherein the first determination component is part of the control device and the second determination component is part of the cloud system.

Analyzing whether the data to be transmitted can be transmitted, based on the data transmission characteristic determined, wherein the analyzing is accomplished by means of a first and/or a second analysis component, wherein the first analysis component is part of the control device and the second analysis component is part of the cloud system.

Selecting at least one action from a set of actions in order to adapt the data to be transmitted and/or the transmission path if the data to be transmitted cannot be transmitted, so as to allow the data transmission, wherein the selecting is accomplished by means of a first and/or a second selection component, wherein the first selection component is part of the control device and the second selection component is part of the cloud system.

Performing the at least one selected action by means of a first and/or a second action component, wherein the first action component is part of the control device and the second action component is part of the cloud system.

The data transmission includes the sending of data from the control device to the cloud system (uplink) and/or the sending of data from the cloud system to the control device (downlink). In particular, data can be sent from the control device to one or more cloud systems. It is likewise possible that the control device receives data from one or more cloud systems. Moreover, in accordance with the method it is also possible for multiple control devices to be used for data transmission.

In order to be able to transmit the data timely, reliably, correctly, and/or completely between the at least one control device and the at least one cloud system, first the data transmission characteristic of at least one available transmission path is determined. The determining of the data transmission characteristic can be carried out on the control device side and/or on the cloud system side. If the determining is performed on the cloud system side, the load on the control device can be reduced and its resources can be used for other tasks such as control tasks.

The data transmission characteristic can include at least one of the following: bandwidth of the data transmission path (in the uplink and downlink), number of available data transmission paths, status of a data buffer on the receiving side and/or sending side, a length of transmission, a latency, and/or other parameters. It is therefore possible to ascertain what quantity of data can be transmitted within a certain time.

After the determining, it is analyzed whether the data to be transmitted can be transmitted, based on the data transmission characteristic determined. In particular, it can be considered during the analysis whether the data to be transmitted can be transmitted timely, reliably, correctly, and/or completely between the at least one control device and the at least one cloud system. Furthermore, it can be considered during the analysis whether all functions can be offered or whether functions such as the “firmware update” function, for example, will subsequently be temporarily blocked.

The analyzing can be carried out on the control device side and/or on the cloud system side. If the analyzing is carried out on the cloud system side, the load on the control device can be reduced and its resources can be used for other tasks such as control tasks.

If the analysis shows that the data to be transmitted cannot be transmitted in the present form, according to the method an action is selected from a set of actions in order to adapt the data to be transmitted and/or the transmission path and thus allow the data transmission. The selection of the at least one action can be carried out on the control device side and/or on the cloud system side. If the selection is carried out on the cloud system side, the load on the control device can be reduced and its resources can be used for other tasks such as control tasks. If the performance of the action relates to components of the control device, then the cloud system can send corresponding control commands to the control device that cause the control device to perform the action. In like manner, in the case that the selection was made on the control device side, the control device can send corresponding control commands to the cloud system that cause the cloud system to perform the action. If both the cloud system and the control device are involved in performing the action, corresponding control commands can be transmitted between the cloud system and the control device for this purpose. The performance of the action can be accomplished automatically, semiautomatically, or manually.

If at least one selection has been made, the action is performed, preferably automatically, by the control device and/or the cloud system.

According to the method, the steps of determining, analyzing, selecting, and performing the action can be executed either on the control device side or on the cloud system side. In this regard, not all steps need be executed on the control device side or on the cloud system side, but instead the execution of the steps can be divided between the control device and the cloud system. In like manner, the steps can be executed on both the control device side and the cloud system side. In particular, the method can allow for the respective steps to be executed on the cloud system side or on the control device side as a function of a utilization of the cloud system or of the control device, wherein the switching between execution on the cloud system side and on the control device side can be accomplished automatically.

It can be ascertained by means of the method whether a faulty or defective data transmission could take place between control devices and cloud systems. By performing the selected actions, a satisfactory data transmission between control devices and cloud systems can ultimately be ensured so that the automation system can be operated securely and reliably with a high degree of automation.

In the case of execution of the method (partially) on the cloud side, the resources of the control device are loaded less. Basically, the method allows optimization of the data transmission between control devices and cloud systems.

Furthermore, the method can include the transmitting of data between the control device and the cloud system after the performing of the action. The transmitting can include, in particular, the transmitting of adapted data and/or the transmitting of data over an adapted transmission path, wherein the data and/or the transmission path were adapted during the performance of the action. Consequently, satisfactory data transmission can be ensured and the automation system can be operated securely and reliably with a high degree of automation.

Moreover, the determining of the data transmission characteristic of at least one transmission path can include one of the following: determining a bandwidth of the at least one transmission path, determining the number of available transmission paths, determining a status of a data buffer, determining a length of transmission, determining a latency. By executing one or more of these determination steps, it is possible to reliably ascertain what quantity of data can be transmitted within a certain time. This result of determination can then be provided as a basis for the subsequent analysis.

In particular, the determining of the data transmission characteristic of at least one transmission path can include the determining of the data transmission characteristic in the uplink and/or downlink. A distinction between the data transmission characteristic in the uplink and the downlink allows a more precise determination of the data transmission characteristic and consequently of the quantity of data that can be transmitted from the control device to the cloud system (i.e., in the uplink) and from the cloud system to the control device (i.e., in the downlink) within a certain time. Consequently, the subsequent analysis and selection steps can take place more precisely.

The determining of the data transmission characteristic can include a completed speed test and/or a continuous monitoring of the data transmission characteristic. A completed speed test gives precise information about the quantity of data that it is currently possible to transmit, wherein a continuous monitoring can determine the quantity of data that it is possible to transmit at any point in time with no need to explicitly initiate corresponding tests.

The continuous monitoring can include the continuous monitoring of a data buffer on the sending side and/or on the receiving side and/or the continuous monitoring of a length of transmission. Consequently, the quantity of data that it is possible to transmit can be monitored on the sending side and/or on the receiving side, and possible bottlenecks in the data transmission can be identified. These bottlenecks can be avoided and/or eliminated with suitable actions.

The analyzing of whether the data to be transmitted can be transmitted can be based on the data transmission characteristic determined and a data configuration of data to be transmitted. Moreover, a comparison of data configuration and data transmission characteristic can make it possible to establish whether the data to be transmitted can be transmitted timely, reliably, correctly, and/or completely, as well as allow the selection of suitable actions.

The method can furthermore include the ascertaining of the data configuration of the data to be transmitted, wherein the data configuration can include at least one of the following configuration parameters: a quantity of data, a data type, a priority of the data, a required security level, and/or a required redundancy. The data type can specify, for example, what type of data (sensor data, log data, control commands, updates, alarm messages, . . . ) is involved. The priority of the data can be chosen to be different. For example, different data types can have different priorities. Similarly, the priority of the data can change, for example the priority can be raised when the data are stored in a data buffer for a relatively long time without already having been sent. The required security level or the required redundancy can specify whether the data must additionally be encrypted at transmission or must be sent with correspondingly high redundancy, for example in order to allow error correction procedures.

The set of actions from which the at least one action to be performed is selected can contain at least one of the following actions: a prioritization procedure, a data reduction procedure, a function reduction procedure, adaptation of a transmission interval, use of an alternative and/or additional transmission path, and/or use of an alternative and/or additional transmission method.

In the prioritization procedure, higher priority data are sent first. In the data reduction procedure, the data are compressed and/or data to be transmitted can be omitted. This can be accomplished through methods such as publishing, changing a sampling rate, deactivating the transmission of whole collection groups (i.e., a group or a collection of data points) or deactivating the transmission of individual data points, for example. Similarly, data reduction rules can be applied in order to reduce the quantity of data. For example, the data to be transmitted can be aggregated. This includes, for example, the transmission of minimum values and/or maximum values instead of entire value ranges and/or the transmission of average values instead of entire value ranges. Furthermore, the quantity of data can be reduced by the means that data are transmitted only when it is established that a value of a monitored parameter of the automation system changes greatly. A great change in the parameter in question can be established when it falls below or exceeds a predefined limit value, or a rate of change of the value deviates from a permissible rate of change.

Function reduction procedures can reject (for the moment) the transmission of large files, such as firmware updates or log files, or temporarily block functions such as remote access. In particular, functions that require the transmission of large quantities of data can be temporarily blocked.

Furthermore, alternative and/or additional transmission paths or transmission methods can be used in order to increase the bandwidth and thus the possible data transmission quantity. To this end, the data transmission can be divided and take place through a further control device or a further gateway or a further transmission path.

In particular, the alternative and/or additional transmission path can be a transmission path of a further control device. Consequently, the transmission path of the further control device can be used as a gateway for a time in order to increase the bandwidth in the short term.

The at least one transmission path can be set up to be wired and/or wireless. Within an automation or control system, both wired and wireless transmission paths can be used for data transmission. In particular, the data can be transmitted in parallel and/or serially from at least one control device to multiple cloud systems.

Furthermore, the object is attained by a method for controlling an automation system by means of a control device, preferably by means of a PLC control device. In order to control the automation system, the control device here uses the above-described method for optimizing data transmission in the automation system between the control device and at least one cloud system. By means of this method, the automation system can be operated reliably and securely, since secure and reliable data transmission between control device and cloud system can be ensured.

Furthermore, the object is attained by a control device, in particular a PLC control device, wherein the control device is set up for optimizing data transmission in an automation system between the control device and at least one cloud system. The control device in this case contains a data transmission device and a component device that includes at least one of the following components: a determination component, set up for determining a data transmission characteristic of at least one transmission path that is available for data transmission; an analysis component, set up for analyzing whether the data to be transmitted can be transmitted, based on the data transmission characteristic determined; a selection component, set up for selecting at least one action from a set of actions in order to adapt the data to be transmitted and/or the transmission path if the data to be transmitted cannot be transmitted, so as to allow the data transmission; and/or an action component, set up for performing the at least one selected action.

Furthermore, the object is attained by a cloud system that is set up for optimizing data transmission in an automation system between a control device and the cloud system. The cloud system contains a data transmission device and a component device that includes at least one of the following components: a determination component, set up for determining a data transmission characteristic of at least one transmission path that is available for data transmission; an analysis component, set up for analyzing whether the data to be transmitted can be transmitted, based on the data transmission characteristic determined; a selection component, set up for selecting at least one action from a set of actions in order to adapt the data to be transmitted and/or the transmission path if the data to be transmitted cannot be transmitted, so as to allow the data transmission; and/or an action component, set up for performing the at least one selected action.

Furthermore, the object is attained by a control system, comprising the above-described control device and the above-described cloud system, wherein the control system is set up to execute the above-described method. The respective components of the component device can be implemented on both the control device side and the cloud system side in this case. The implementation can be accomplished in hardware and/or software.

Furthermore, the object is attained by a computer program that includes instructions which can be executed by one or more processors, wherein the instructions when executed cause the one or more processors to execute the above-described method.

The advantages described in connection with the method can be attained in each case with the control device, the cloud system, the control system, and the computer program.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic flowchart of a method for optimizing data transmission;

FIGS. 2A to 2C are schematic representations of a control device and a cloud system;

FIG. 3 is a schematic representation of a control system; and

FIG. 4 is a schematic representation of a component device.

### DETAILED DESCRIPTION

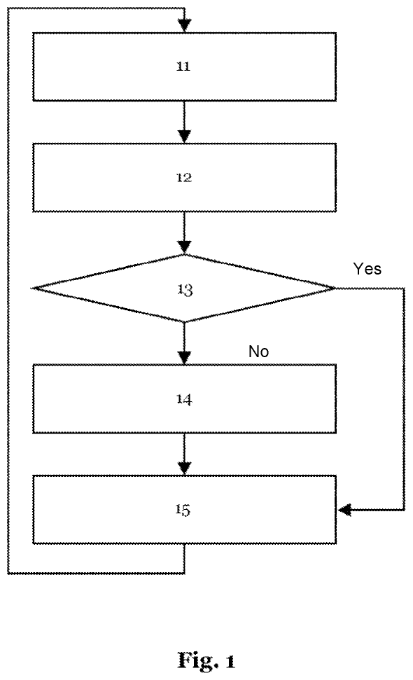

In particular, FIG. 1 shows a schematic flowchart of a method 10. The method 10 includes the steps of determining 11, analyzing 12, selecting 13, performing 14, as well as—optionally — transmitting 15 data.

In the first step 11, a data transmission characteristic of at least one transmission path that is available for data transmission is determined. This is accomplished by means of a first and/or a second determination component that is arranged on the control device side or on the cloud system side.

In a second step 12, it is analyzed whether the data to be transmitted can be transmitted, based on the data transmission characteristic determined and optionally on a data configuration of data to be transmitted. The analyzing 12 is accomplished by means of a first and/or a second analysis component, wherein the first analysis component is part of the control device and the second analysis component is part of the cloud system.

In a third step 13, if the data to be transmitted cannot be transmitted, at least one action is selected from a set of actions in order to adapt the data to be transmitted and/or the transmission path so as to allow the data transmission. The selecting 13 is accomplished by means of a first and/or a second selection component, wherein the first selection component is part of the control device and the second selection component is part of the cloud system. If the analysis in step 12 shows that the data to be transmitted can be transmitted, it is possible to continue immediately with step 15 without an action being selected and/or performed.

In a fourth step 14, the at least one selected action is performed by means of a first and/or a second action component, wherein the first action component is part of the control device and the second action component is part of the cloud system.

In a fifth step 15, the data are transmitted. The transmission can take place from the control device to the cloud system or from the cloud system to the control device. The method is not limited to one control device and one cloud system, but rather can be carried out with any number of control devices and/or cloud systems.

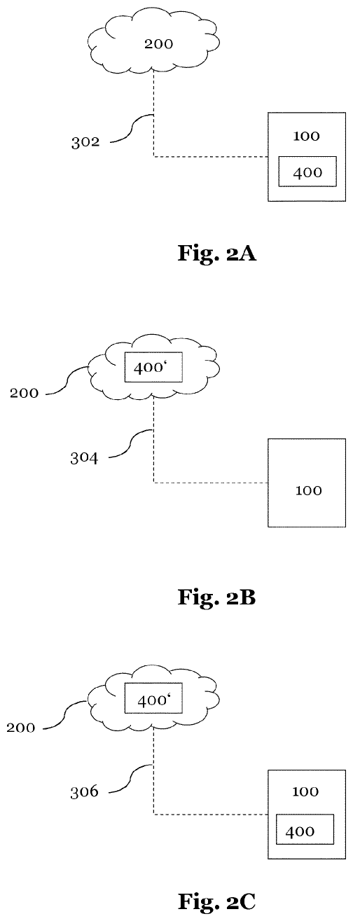

FIGS. 2A to 2C show different configurations of control devices 100 and cloud systems 200 that in each case can transmit data through a data transmission path 302, 304, 306. The data transmission can take place in both directions here, which is to say from the control device 100 to the cloud system 200 or from the cloud system 200 to the control device 100.

In the first configuration according to FIG. 2A, the control device 100 includes a component device 400, which is described in detail in connection with FIG. 4. The cloud system 200 does not include a corresponding component device. In this configuration, the method described would be executed solely by the control device 100.

In the second configuration according to FIG. 2B, the control device 100 does not include a component device. Instead, the cloud system 200 includes a corresponding component device 400′. The component device 400′ corresponds to the component device 400, which is described in detail in connection with FIG. 4. In this configuration, the method described would be executed solely by the cloud system 200.

In the third configuration according to FIG. 2C, both the control device 100 and the cloud system 200 include a corresponding component device 400, 400′. In this configuration, the execution of the method described can be divided between the cloud system 200 and the control device 100. This division is not necessarily statically defined, but instead the division of the execution of the individual method steps can take place dynamically, wherein the utilization of the control device 100 and/or of the cloud system 200 is considered in the division.

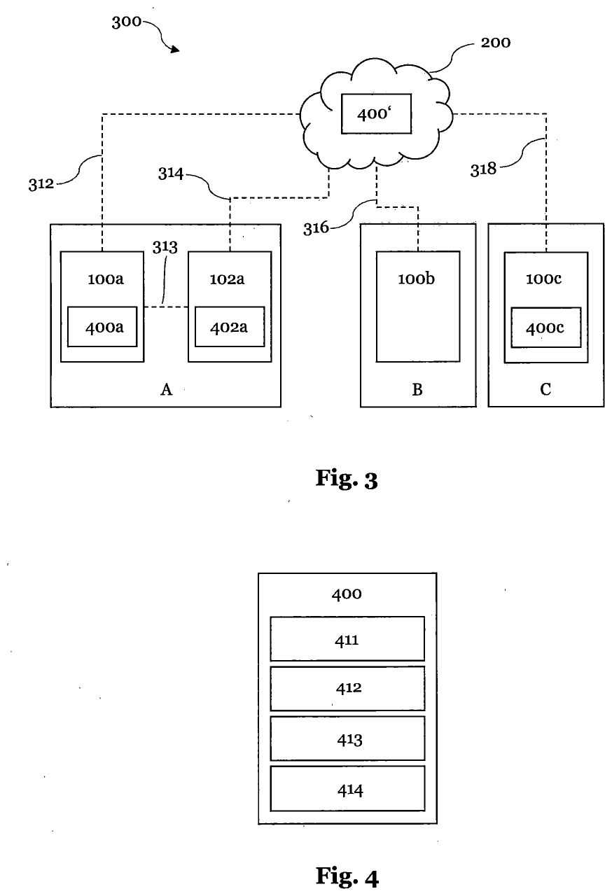

FIG. 3 shows a schematic representation of a control system 1, which includes a multiplicity of control devices 100a, 102a, 100b, 100c, and a cloud system 200. The control devices 100a, 102a are arranged at a first location A, the control device 100b at a second location B, and the control device 100c at a third location C, wherein the locations A, B, and C are spatially separated from one another. The control devices 100a, 102a, 100b, 100c and the cloud system 200 are connected to one another through a data transmission network 300 comprising transmission paths 312, 313, 314, 316, 318. Data transmission in the data transmission network 300 can be optimized in accordance with the method 10. In particular, the control device 100a can use the control device 100b or the transmission paths 313, 314 as a gateway in order to be able to provide a higher data transmission rate in the short term. Transmission paths 312, 313, 314, 316, 318 can each be wireless or wired.

FIG. 4 shows a schematic representation of a component device 400, which includes at least one of the following components: a determination component 411, set up for determining a data transmission characteristic of at least one transmission path that is available for data transmission; an analysis component 412, set up for analyzing whether the data to be transmitted can be transmitted, based on the data transmission characteristic determined and optionally on a data configuration of data to be transmitted; a selection component 413, set up for selecting at least one action from a set of actions in order to adapt the data to be transmitted and/or the transmission path if the data to be transmitted cannot be transmitted, so as to allow the data transmission; and/or an action component 414, set up for performing the at least one selected action.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for optimizing data transmission in an automation system between a control device and at least one cloud system, the method comprising:
determining a data transmission characteristic of at least one transmission path that is available for data transmission by a first and/or a second determination component, the first determination component being part of the control device and the second determination component being part of the cloud system;
analyzing whether the data to be transmitted is adapted to be transmitted, based on the data transmission characteristic determined, the analyzing being accomplished via a first and/or a second analysis component, the first analysis component being part of the control device and the second analysis component being part of the cloud system;
selecting at least one action from a set of actions in order to adapt the data to be transmitted and/or the transmission path if the data to be transmitted cannot be transmitted, so as to allow the data transmission, the selecting being accomplished via a first and/or a second selection component, the first selection component being part of the control device and the second selection component being part of the cloud system; and
performing the at least one selected action via a first and/or a second action component, the first action component being part of the control device and the second action component being part of the cloud system.

2. The method according to claim 1, further comprising: transmitting data between the control device and the cloud system after the performing of the action.

3. The method according to claim 1, wherein the determining of the data transmission characteristic of at least one transmission path includes at least one of:
determining a bandwidth of the at least one transmission path,
determining the number of available transmission paths,
determining a status of a data buffer,
determining a length of transmission, and/or
determining a latency.

4. The method according to claim 1, wherein the determining of the data transmission characteristic of at least one transmission path includes the determining of the data transmission characteristic in the uplink and/or downlink.

5. The method according to claim 1, wherein the determining of the data transmission characteristic includes a completed speed test and/or a continuous monitoring of the data transmission characteristic.

6. The method according to claim 5, wherein the continuous monitoring includes the continuous monitoring of a data buffer on the sending side and/or on the receiving side and/or the continuous monitoring of a length of transmission.

7. The method according to claim 1, wherein the analyzing of whether the data to be transmitted is to be transmitted is based on the data transmission characteristic determined and a data configuration of data to be transmitted.

8. The method according to claim 1, wherein the method further comprises ascertaining of the data configuration of the data to be transmitted, and wherein the data configuration includes at least one of the following configuration parameters: a quantity of data, a data type, a priority, a required security level, and/or a required redundancy.

9. The method according to claim 1, wherein the set of actions comprises at least one of the following actions:
a prioritization procedure,
a data reduction procedure,
a function reduction procedure,
adaptation of a transmission interval,
use of an alternative and/or additional transmission path, and/or
use of an alternative and/or additional transmission method.

10. The method according to claim 9, wherein the alternative and/or additional transmission path is a transmission path of a further control device.

11. The method according to claim 1, wherein the at least one transmission path is arranged to be wired and/or wireless.

12. The method according to claim 1, wherein the data are transmitted in parallel and/or serially from at least one control device to multiple cloud systems.

13. A method for controlling an automation system via a control device, preferably a PLC control device, wherein the control device uses, in order to control the automation system, the method according to claim 1 for optimizing data transmission in the automation system between the control device and at least one cloud system.

14. A control device, in particular a PLC control device, set up for optimizing data transmission in an automation system between the control device and at least one cloud system, the control device comprising:
a data transmission device; and
a component device that includes at least one of:
a determination component set up for determining a data transmission characteristic of at least one transmission path that is available for data transmission;
an analysis component set up for analyzing whether the data to be transmitted can be transmitted, based on the data transmission characteristic determined;
a selection component set up for selecting at least one action from a set of actions in order to adapt the data to be transmitted and/or the transmission path if the data to be transmitted cannot be transmitted, so as to allow the data transmission; or
an action component set up for performing the at least one selected action.

15. A cloud system set up for optimizing data transmission in an automation system between a control device and the cloud system, wherein the cloud system comprises:
a data transmission device; and
a component device that comprises at least one of:
a determination component set up for determining a data transmission characteristic of at least one transmission path that is available for data transmission;
an analysis component set up for analyzing whether the data to be transmitted can be transmitted, based on the data transmission characteristic determined;
a selection component set up for selecting at least one action from a set of actions in order to adapt the data to be transmitted and/or the transmission path if the data to be transmitted cannot be transmitted, so as to allow the data transmission; or
an action component set up for performing the at least one selected action.

16. The control system comprising a control device according to claim 14 and a cloud system, wherein the control system is set up to execute a method comprising:
determining a data transmission characteristic of at least one transmission path that is available for data transmission by a first and/or a second determination component, the first determination component being part of the control device and the second determination component being part of the cloud system;
analyzing whether the data to be transmitted is adapted to be transmitted, based on the data transmission characteristic determined, the analyzing being accomplished via a first and/or a second analysis component, the first analysis component being part of the control device and the second analysis component being part of the cloud system;
selecting at least one action from a set of actions in order to adapt the data to be transmitted and/or the transmission path if the data to be transmitted cannot be transmitted, so as to allow the data transmission, the selecting being accomplished via a first and/or a second selection component, the first selection component being part of the control device and the second selection component being part of the cloud system; and
performing the at least one selected action via a first and/or a second action component, the first action component being part of the control device and the second action component being part of the cloud system.

17. A computer program, comprising instructions that are adapted to be executed by one or more processors, wherein the instructions when executed cause the one or more processors to execute the method according to claim 1.

18. The method according to claim 1, wherein the control device is a PLC control device.
